(19) United States
(12) Patent Application Publication
(10) Pub. No.: US 2021/0012008 A1
(43) Pub. Date: Jan. 14, 2021

(54) METHOD OF INITIALIZING DEVICE AND METHOD OF UPDATING FIRMWARE OF DEVICE HAVING ENHANCED SECURITY FUNCTION

(71) Applicant: SECURITYPLATFORM, Seongnam-si (KR)

(72) Inventors: Kyung Mo KIM, Seongnam-si (KR); Yong Kwan PARK, Seongnam-si (KR)

(21) Appl. No.: 16/463,605

(22) PCT Filed: Sep. 20, 2017
(86) PCT No.: PCT/KR2017/010351

§ 371 Date: May 23, 2019

(30) Foreign Application Priority Data
Sep. 27, 2016 (KR) 10-2016-0124174

(51) Int. Cl. G06F 21/57; G06F 21/64; G06F 21/60; G06F 8/65; H04L 29/06; H04L 9/32

(52) U.S. Cl. CPC G06F 21/572; G06F 21/64; G06F 21/602; G06F 2221/034; H04L 63/0435; H04L 9/3247; G06F 8/65

(57) ABSTRACT

A method of initiating a device managed by an authorized manager includes maintaining a security module connected to the device in hardware and an encrypted firmware image; loading the encrypted firmware image; confirming integrity of the encrypted firmware image by reading a header of the encrypted firmware image using a public key of the manager stored in the security module; decrypting an encrypted symmetric key in the encrypted firmware image by using the encryption key of the security module when the integrity of the encrypted firmware image is confirmed; decrypting encrypted firmware of the encrypted firmware image using the decrypted public key; and executing the decrypted firmware in the device.

### TECHNICAL FIELD

The present invention relates to security of a device, and more particularly, to an initialization method and a firmware update method of a device capable of improving the security of an IoT device that may be easily exposed to an external attack.

### BACKGROUND ART

Electronic devices are becoming gradually complicated and include a variety of information. As a result of the development of the Internet of Things and the like, one device serves as a security defect such as personal information exchange, remote operation, and the like while communicating with another device or a user.

In general, many devices include hardwareized software such as firmware. Firmware is the middle of software and hardware and may hardwareize software. That is, the firmware has high fixity and may be called a basic program or data stored in an ROM in order to increase the efficiency of the system, and in some cases, in a microcomputer, the firmware may be called a ROM in which programs are included because almost all programs are stored in the ROM.

The firmware has been used in many electronic devices because some of the hardware's functions are replaced with software and functions of the device may be controlled or improved with low cost in a very simple manner.

However, since the firmware has a software characteristic, the firmware is subject to hacking or forgery, and accordingly, a method of verifying the firmware with integrity has been developed.

In this regard, WO2014/134389 discloses a technique for “Continuation of trust for platform boot firmware”. According to Adams' invention, the device includes a processing module and a memory module, wherein the memory module includes a ROM in which a platform boot firmware is stored, and the processing module may load the platform boot firmware when the device is activated.

The platform boot firmware loads and verifies the signature of a hash table loaded from the platform boot firmware, and first loads a trusted program file by the processing module. Thereafter, the processing module loads other files from the platform boot firmware, calculates a hash for each file, and verifies whether a hash corresponding to each program file is present in the hash table. Program files with hashes in the hash table may be allowed to be executed. When no hash corresponding to the loaded program file exists in the hash table, the processing module performs platform specific security actions to prevent the device from being damaged.

However, the invention of Adams has a disadvantage in that since the common signature is provided to a device manufactured by one manufacturer, there is a problem that other devices are also exposed when one device is exposed, and since only one signature is confirmed even in the platform boot firmware, the security is poor.

### DISCLOSURE

### Technical Problem

The present invention relates to an initialization method and a firmware update method of a device capable of safely maintaining security against hacking from the outside by mounting a security module on a device in hardware.

The present invention relates to an initialization method and a firmware update method of a device capable of maintaining security doubly or more by maintaining a firmware of the device in an encrypted binary image, verifying a signature of the firmware with an encryption key of a manufacturer whenever initiation, decrypting a symmetric key used to encrypt the firmware with a unique encryption key of the device, and decrypting the firmware using the symmetric key.

The present invention relates to an initialization method and a firmware update method of a device which can not normally operate in other devices even through a firmware image of another device is duplicated by maintaining another asymmetrical encryption key every device and encrypting and decrypting a symmetric key using another encryption key for each device.

### Technical Solution

In order to achieve the objects of the present invention, according to an embodiment of the present invention, there is provided a method of initiating a device managed by an authorized manager including: maintaining a security module connected to the device in hardware and an encrypted firmware image; loading the encrypted firmware image; confirming integrity of the encrypted firmware image by reading a header of the encrypted firmware image using a public key of the manager stored in the security module; decrypting an encrypted symmetric key in the encrypted firmware image by using encryption key of the security module when the integrity of the encrypted firmware image is confirmed; decrypting encrypted firmware included in the encrypted firmware image by using the decrypted symmetric key; and executing the decrypted firmware in the device.

In this specification, the authorized manager is a person authorized to drive the device or update the firmware, a person who has been delegated the management of firmware, etc. from a manufacturer of the device or its manufacturer, and also a person who purchases the device from the manufacturer or receives and uses the device. The present invention is to prevent a device from hacking or operating by firmware arbitrarily manipulated by a third party other than the authorized manager and characterized by storing the firmware as an encrypted binary image, decrypting an encrypted symmetric key with a unique encrypted key of the device even in the initiation process and the firmware update process, and decrypted the encrypted firmware with the decrypted symmetric key.

Since the unique encrypted key of the device is different from other devices of the same kind, the encrypted key does not normally operate even by duplicating the firmware image of another device, and may protect the firmware from being analyzed like reverse engineering because the firmware itself is encrypted.

According to the present invention, even in any one of the confirming of the integrity or the decrypting of the symmetric key in the initiating process, when an error occurs, it is possible to basically prevent the modified firmware from being loading or the firmware from being analyzed by immediately stopping the initiation of the device.

Above all, the security module used for the device may be installed in the device as a hardware like a chip. The security module may have an anti-penetration function itself and may be provided in the form of a built-in security chip, a micro SD card or a smart card. Since the built-in security chip is mounted on a PCB and used, there is an advantage that the information about the security chip may not be confirmed by a third party other than the manufacturer.

To this end, the security module may include a public key of the manager and an encryption key or a private key of the security module, and the firmware of the device supplied through a normal route is provided in the form of an encrypted firmware image, and the firmware image may include a signature encrypted by the secret key or private key of the manager, a symmetric key encrypted by the encryption key or private key of the security module, and firmware encrypted by the symmetric key.

For reference, the security module may use different encryption keys even for the same type of devices, and only the manufacturer or the manager may verify the encryption key of the security module. Therefore, the firmware image generated for one device may not normally operate in another device.

The encrypted signature in the encrypted firmware image may be located in the header and the header may further include at least one of a magic number, a version, a firmware length, and a signature length.

In order to achieve the objects of the present invention, according to another embodiment of the present invention, there is provided a method of updating a device using an encrypted firmware update image provided by an authorized manager, including: maintaining a security module connected to the device in hardware; storing the encrypted firmware update image; loading the encrypted firmware update image; confirming integrity of the encrypted firmware update image by reading a header of the encrypted firmware update image using a public key of the manager stored in the security module; and copying the encrypted firmware update image to a memory in which the existing encrypted firmware image is stored when the integrity of the encrypted firmware update image is confirmed.

The encrypted firmware update image may be newly stored as the encrypted firmware image and may be executed when booting the device according to the aforementioned initiating method. However, when the symmetric key in the encrypted firmware image may not be decrypted with the secret key of the device even if the integrity is confirmed, the initialization may be stopped, and since the symmetric key is not decrypted, it is possible to prevent abnormal firmware from being loaded on the device.

### Advantageous Effects

According to the initiation method and the firmware update method of the present invention, it is possible to safely maintaining security against hacking from the outside by using a security module mounted on a device in hardware.

Further, since the firmware of the device is not stored as it is, but is kept as a binary image encrypted using the encryption key of the security module, it is possible to verify a signature of the firmware with an encryption key of a manufacturer whenever initiation, decrypt a symmetric key used to encrypt the firmware with a unique encryption key of the device, and decrypt the firmware using the symmetric key. As a result, it is possible to prevent the abnormally modified firmware image from being loaded in the device and safely maintain the security by protecting doubly the symmetric key encrypting the firmware with encryption keys of the security module and the manager.

Further, according to the initiation method and the firmware update method of the present invention, by maintaining a different asymmetric encryption key for each device and encrypting and decrypting the signature of the firmware image using a different secret key for each device, even if the firmware image of another device is duplicated, the firmware may not normally operate even in other devices.

### DESCRIPTION OF DRAWINGS

FIG. 1 is a diagram for describing a device according to an embodiment of the present invention.

FIG. 2 is a diagram for describing a mutual authentication process between a gateway of a manager and a device according to an embodiment of the present invention.

FIG. 3 is a diagram for describing a key exchange process between a gateway of a manager and a device according to an embodiment of the present invention.

FIG. 4 is a diagram for describing a structure of a firmware image according to an embodiment of the present invention.

FIG. 5 is a diagram for describing a method of initiating a device according to an embodiment of the present invention.

FIG. 6 is a diagram illustrating a method of updating firmware of a device according to an embodiment of the present invention.

### MODES OF THE INVENTION

Hereinafter, embodiments of the present invention will be described in detail with reference to the accompanying drawings, but the present invention is not limited or restricted to the embodiments. For reference, in the description, like reference numerals substantially refer to like elements, which may be described by citing contents disclosed in other drawings under such a rule and contents determined to be apparent to those skilled in the art or repeated may be omitted.

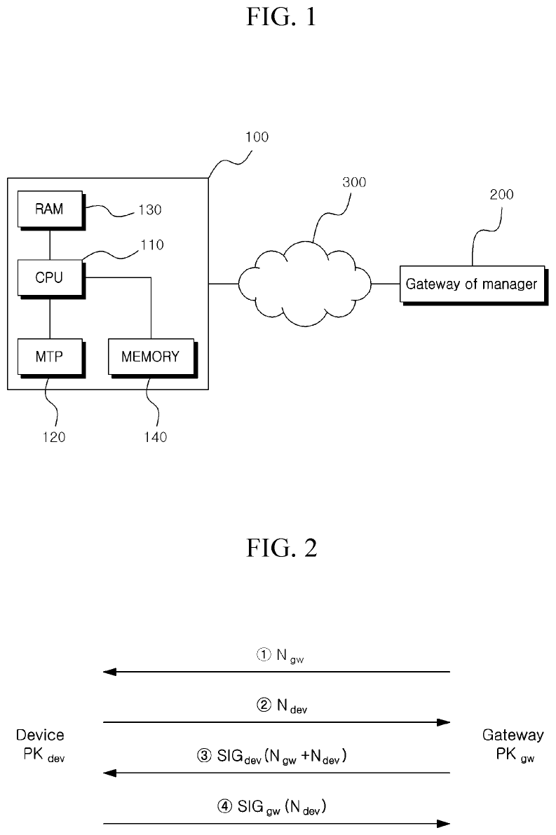

FIG. 1 is a diagram for describing a device according to an embodiment of the present invention.

Referring to FIG. 1, a device 100 includes a CPU 110, a RAM 130, a security module 120, and a storage unit 140 maintaining an encrypted firmware image. Here, the device 100 may be an electronic device that can be operated by firmware and may include general electronic devices, for example, low-performance equipment such as a set-top box, a television, a refrigerator, a router, and other controllers, and may also include high-performance equipment such as a general computing device, a smart phone, and a tablet.

The firmware may be stored in the storage unit 140, and in the embodiment, the firmware may be stored in an encrypted binary image format instead of an executable file format which may be immediately executed, and may be encrypted with unique encryption keys of a manager and the security module. In addition, the encrypted firmware image cannot perform a normal operation before verifying the signature using the encryption key stored in the security module 120 and decrypting the encrypted symmetric key.

In the embodiment, the device 100 is connected with the gateway 200 of the manager via the network 300 and may register the device through the gateway 200 of the manager or receive a firmware update image. However, in addition, the device 100 may transmit and receive required information or data via a different network from the manager and may receive or store the firmware image or the firmware update image by driving a specific application in the PC.

In the device 100, the security module 120 may be directly mounted on a PCB of the device 100 as hardware. In the embodiment, the security module 120 may include a public key of the manager and a secret key or a private key of the security module as a security chip or an encryption chip, and the security module 120 may safely store other sensitive data.

Specifically, the security module 120 in the form of a security chip basically has a penetration prevention function, and for example, an Optiga Trust P product from Infineon Corporation may be used. The security module 120 may include functions such as authentication, security update, key generation and storage, storage space protection, securing of integrity of a storage space, secure boot (COS use in a chip), and access control, and may have a defense function against attacks such as physical attacks from the outside, sub-channel attacks, and error insertion. The security module 120 as hardware may protect an embedded system from falsification, duplication or operational errors of the firmware.

In the embodiment, the security module 120 is provided in the form of a security chip mounted on the PCB, and in another embodiment, the security module may be provided in the form of a universal IC card (UICC), a micro SD card, and a smart card.

The gateway 200 of the manager may be a gateway that adds various defense functions such as using the security module 120 to the functions of the existing general gateway. The gateway 200 of the embodiment may include an Integrity Measurement Architecture/Extended Verification Module (IMA/EVM™) function for limiting a binary not authenticated or signed by the manufacturer or manager not to be used and also include a function of Simple Mandatory Access Control in Kernel (SMACK™) as a kind of MAC for limiting a binary signed by the manufacturer or manager to approach only a pre-allowable resource.

Here, the gateway 200 of the manager may protect the identity of the device 100 with security functions such as authentication and communication encryption of the device 100, which is equipped with the security module 120, and improve the security.

Device Registration Process

The gateway 200 of the manager may verify whether the other party's device 100 is a registerable device through the mutual authentication process with the device 100 before receiving the data from the device 100. If the mutual authentication is failed, the gateway 200 may terminate a session.

The gateway 200 and the device 100 require each other party's public key to perform mutual verification. The other party's public key can be registered in a separate device registration process before the device 100 is manufactured or installed. The public key of the device 100 may be registered in a GUI of the gateway 200 and the public key of the gateway 200 may also be registered in the security module 120 by executing an initialization execution file for mbedTM.

FIG. 2 is a diagram for describing a mutual authentication process between a gateway of a manager and a device according to an embodiment of the present invention.

Referring to FIG. 2, the mutual authentication process between the gateway 200 and the device 100 may be performed in the following steps. First, the gateway 200 generates a NONCE and transmits the generated NONCE to the device 100 (\textcircled{1}). The device 100 receives the NONCE of the gateway 200 and then transmits its NONCE to the gateway 200 (\textcircled{2}).

After receiving the NONCE of the device 100, the gateway 200 merges the received NONCE of the device 100 with the NONCE of the gateway 200, signs the merged NONCE with its secret key or private key, and then transmits the signed secret key to the device 100 (\textcircled{3}). Then, the device 100 verifies the signature sent from the gateway 200 using the public key of the gateway 200. If the verification is successful, the NONCE value of the gateway is signed with the secret key of the security module 120 and transmitted to the gateway 200 (\textcircled{4}).

After receiving the signature from the device 100, the gateway 200 may verify the signature of the device 100, and if all of the above processes are normally performed, then the gateway 200 and the device 100 may stably exchange the data with each other.

Communication Encryption

The gateway 200 of the manager and the device 100 may perform a communication encryption operation to safely exchange the data. To this end, it is necessary to exchange keys to be used for communication encryption. For key exchange, for example, a Diffie-Hellman (DH) algorithm may be used and ECDSA may be used for key generation.

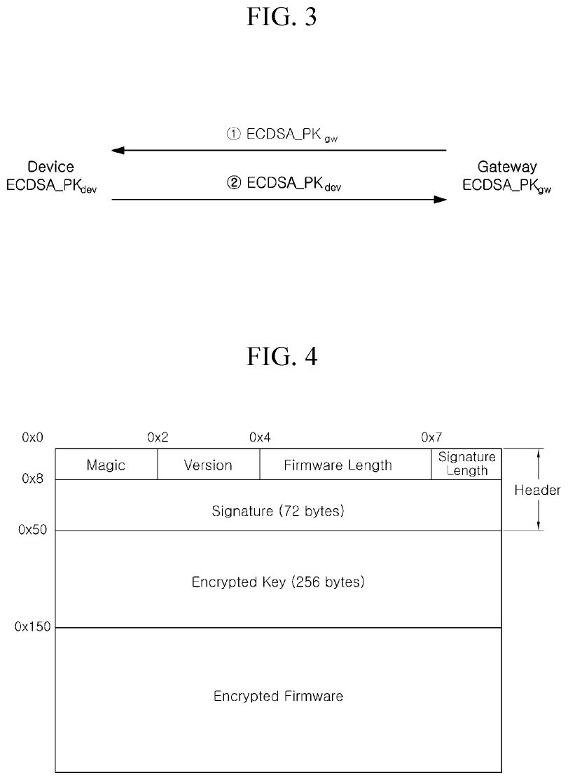

FIG. 3 is a diagram for describing a key exchange process between a gateway of a manager and a device according to an embodiment of the present invention.

Referring to FIG. 3, a key exchange process between the gateway 200 and the device 100 may be performed in the following steps. First, the gateway 200 may transmit its ECDSA public key to the device 100. The device 100 may generate a secret key having the received ECDSA public key of the gateway 200 and an ECDSA secret key of the device 100 and to be used for the encryption communication.

Then, the device 100 may transmit its own ECDSA public key to the gateway 200 and the gateway 200 may generate an encryption key having the received ECDSA public key of the device 100 and an ECDSA secret key of the gateway 200 and to be used for the encryption communication.

The secret keys generated by the gateway 200 and the device 100 through the key exchanging process may be the same as each other, and the data is exchanged using a symmetric-key algorithm with the secret keys.

Device Initialization

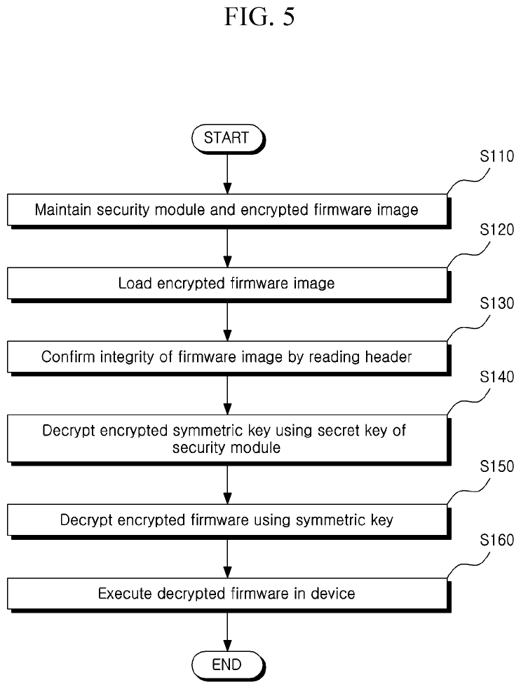

FIG. 4 is a diagram for describing a structure of a firmware image according to an embodiment of the present invention and FIG. 5 is a diagram for describing a method of initiating a device according to an embodiment of the present invention.

Referring to FIGS. 4 and 5, a device 100 includes a security module 120 mounted as hardware and a storage unit 140 maintaining an encrypted firmware image (S110). When the power is supplied or booting is required, the device 100 loads the firmware image stored at a specific address of the storage unit 140 before executing the firmware (S120).

The device 100 confirms whether the encrypted firmware image is forged or falsified during the booting process using the security module 120 mounted as hardware, and if it is determined that the encrypted firmware image is normal, the device 100 decrypts the firmware and then normally performs the firmware.

Whether the firmware image is forged or falsified may be confirmed in a boot loader. The firmware image includes the firmware in the form of a binary image while being encrypted, and a header containing information on the firmware image is attached in front of the image.

As illustrated in FIG. 4, the encrypted firmware image may include a header, a symmetric key encrypted by an encryption key of the security module 120, and firmware encrypted by the symmetric key, and the header of the firmware image may include a magic member, version information, a firmware length, a signature length, and a signature encrypted by an encryption key or a secret key of the gateway 200.

Here, the magic number is a value for determining whether a firmware image exists or not, and the version information includes a version of the firmware image, and the configuration and size of the header may be changed according to the version value. The firmware length may mean the length of the firmware image excluding the header, and the signature may use a SHA256 ECDSA Signature of the data excluding the header.

The encrypted symmetric key may be data obtained by encrypting a symmetric key for encrypting the firmware, for example, an AES128 key with a public key of a device, for example, a RSA2048 public key, and the encrypted firmware may be data obtained by encrypting firmware supplied by the manufacturer or the manager with a symmetric key, for example, a AES 128 key.

The boot loader may confirm the magic number in the header of the firmware image to confirm whether the encrypted firmware is present in a flash. Thereafter, the boot loader may confirm the version of the header. In the embodiment, the structure of the header may be changed according to the version of the header, which may be flexibly handled by considering a case where there are additional variables required in the header.

ECC verification may be performed to confirm the integrity of the firmware image (S130). An object to be verified for integrity is a remaining part of the firmware image excluding the header, and an ECC public key of the manager required for verification may already exist in the security module 120. The remaining part excluding the header may include the encrypted symmetric key and the firmware encrypted by the symmetric key.

When the integrity of the encrypted firmware image is confirmed, the device 100 may decrypt the encrypted symmetric key encrypted by using a unique secret key or a private key of the security module 120 and obtain a symmetric key for decrypting the firmware, the AES128 key in the embodiment (S140). The algorithm used for decrypting the symmetric key may be RSA 2048 and an RSA key used for decryption may be a key generated by the device 100 itself through the security module 120.

The encrypted firmware of the firmware image is decrypted with the obtained symmetric key (S150), and the firmware is executed by jumping to an address where the firmware is located (S160). In the embodiment, the symmetric key may be an encryption key arbitrarily selected by the manager for each device, and may be already stored in the security module 120.

If the integrity of the firmware image is not confirmed during the initialization or if an error occurs in the process of decrypting with the unique encryption key stored in the security module 120, the device 100 stops the initiation process to prevent the forgery-suspected firmware from being executed in the device 100.

Update of Firmware Image

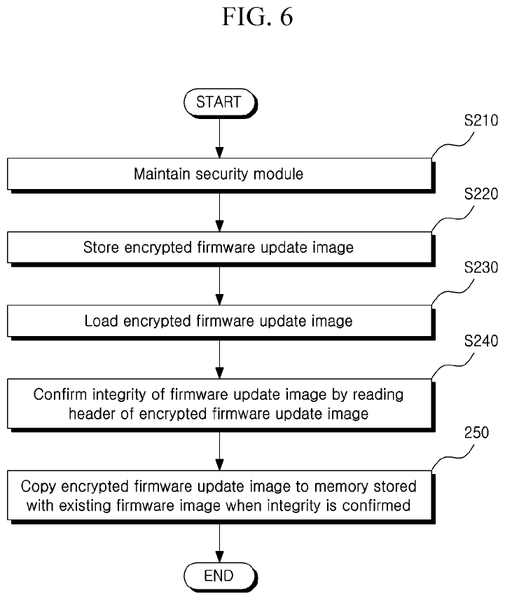

FIG. 6 is a diagram illustrating a method of updating firmware of a device according to an embodiment of the present invention.

Referring to FIG. 6, the device 100 basically includes the security module 120 as hardware (S210). However, the firmware may be updated according to the provision of the manager, and if the firmware of the device 100 needs to be updated, a required firmware update image may be received and stored from the manager (S220). In the embodiment, the firmware update image may be received from the manager via the wired or wireless network, and if the firmware update image is larger than the memory, the firmware update image may be divided and received in segments from a server.

When the firmware update image is received at once, the firmware update image may be divided and received because the memory may be insufficient. The device 100 may receive the firmware update image in segments and store the received firmware update image in a temporary space of the flash. When the device 100 receives all the segments, the device 100 loads the firmware update image to confirm whether the firmware update image is falsified or whether the official firmware provided by the manufacturer or the manager is correct (S230), and reads a header of the firmware update image to perform ECC verification to confirm integrity (S240).

As described above, the firmware update image also includes a header and a main body, and the header may include a magic number, version information, a firmware length, a signature length, and an encrypted signature, and the main body may also include an encrypted symmetric key and encrypted firmware.

First, like the above-described initialization method, the device 100 checks the magic number and the version information and calculates an ECC signature using the public key of the manager to compare the calculated ECC signature with the signature included in the header. The ECC public key used for ECC verification is provided by the server and needs to be installed in the security module 120 of the device 100 before updating.

When the ECC verification is completed, it is confirmed that the firmware update image provided by the manufacturer or the manager has not been falsified during transmission, so that the firmware update image stored in the temporary space may be copied to a place where the existing firmware image is located (S250).

Firmware Encryption

To prevent leakage and falsification of the firmware, the firmware may be transmitted between the manager and the device in the form of an encrypted binary image, and the firmware image or the firmware update image received by the device 100 is stored in the storage unit 140.

The encryption of the firmware may use the AES128 algorithm. A symmetric key to be used in the AES 128 may be generated at the manager server or at the gateway. When the firmware is encrypted using the generated symmetric key, the AES 128 key may also be encrypted to prevent leakage of the symmetric key.

For example, RSA2048 may be used to encrypt the AES128 key. An encryption key to be used for the RSA 2048 is generated according to the security module 120 of the device 100 respectively and the manager may encrypt the symmetric key AES 128 key that encrypted the firmware, by using the encryption key distributed by the device 100.

When the encrypted symmetric key (AES128 key) and the encrypted firmware are prepared, an ECC signature is generated to form a header, and a final firmware image or a firmware update image may be generated by connecting the configured header, the encrypted symmetric key (AES128 key), and the encrypted firmware.

As described above, the present invention has been described with reference to the preferred embodiments. However, it will be appreciated by those skilled in the art that various modifications and changes of the present invention can be made without departing from the spirit and the scope of the present invention which are defined in the appended claims and their equivalents.

1. A method of initiating a device managed by an authorized manager comprising:
maintaining a security module connected to the device in hardware and an encrypted firmware image;
loading the encrypted firmware image;
confirming integrity of the encrypted firmware image by reading a header of the encrypted firmware image using a public key of the manager stored in the security module;
decrypting an encrypted symmetric key included in the encrypted firmware image, by using an encryption key of the security module, when the integrity of the encrypted firmware image is confirmed;
decrypting encrypted firmware included in the encrypted firmware image by using the decrypted symmetric key; and
executing the decrypted firmware in the device.

2. The method of initiating a device of claim 1, wherein even in any one of the confirming of the integrity and the decrypting of the encrypted symmetric key, when an error occurs, the initiation of the device is stopped.

3. The method of initiating a device of claim 1, wherein the encrypted firmware image includes a signature encrypted by a secret key of the manager, a symmetric key encrypted by the encryption key of the security module, and firmware encrypted by the symmetric key.

4. The method of initiating a device of claim 3, wherein the encrypted signature in the encrypted firmware image is located in the header and the header further includes at least one of a magic number, a version, a firmware length, and a signature length.

5. A method of updating a device using an encrypted firmware update image provided by an authorized manager, comprising:
maintaining a security module connected to the device in hardware;
storing the encrypted firmware update image;
loading the encrypted firmware update image;
confirming integrity of the encrypted firmware update image by reading a header of the encrypted firmware update image using a public key of the manager stored in the security module; and
copying the encrypted firmware update image to a memory in which the existing encrypted firmware image is stored when the integrity of the encrypted firmware update image is confirmed.

6. The method of updating a device of claim 5, wherein in the confirming of the integrity, when an error occurs, the updating of the device is stopped.

7. The method of updating a device of claim 5, wherein the encrypted firmware update image includes a signature encrypted by a secret key of the manager, a symmetric key encrypted by an encryption key of the security module, and firmware encrypted by the symmetric key.

8. The method of updating a device of claim 7, wherein the encrypted signature in the encrypted firmware update image is located in the header and the header further includes at least one of a magic number, a version, a firmware length, and a signature length.

9. The method of updating a device of claim 5, wherein the symmetric key is arbitrarily selected by the manager for each device.
